(19) United States
(12) Patent Application Publication
(10) Pub. No.: US 2017/0174229 A1
(43) Pub. Date: Jun. 22, 2017

(54) METHOD AND DEVICE FOR MONITORING OR REGULATING A DRIVING TASK TRANSFER IN AN AUTONOMOUS VEHICLE AND SYSTEM FOR A DRIVING TASK TRANSFER IN AN AUTONOMOUS VEHICLE

(71) Applicant: Robert Bosch GmbH, Stuttgart (DE)

(72) Inventor: Alexander Mueller, Bietigheim (DE)

(21) Appl. No.: 15/380,369

(22) Filed: Dec. 15, 2016

(30) Foreign Application Priority Data
Dec. 16, 2015 (DE) 102015225430.5
Apr. 13, 2016 (DE) 102016206126.7

(51) Int. Cl. B60W 50/08; B60W 50/10; G05D 1/00; B60W 50/12

(52) U.S. Cl. CPC B60W 50/082; B60W 50/12; B60W 50/10; G05D 1/0061; G05D 1/0088; B60W 2400/00; B60W 2540/28

(57) ABSTRACT

A method is described for monitoring or regulating a driving task transfer in an autonomous vehicle. The method includes a step of reading in a piece of driving task transfer information from an interface assigned to a vehicle seat of the vehicle, the piece of driving task transfer information representing an intended transfer of the driving task by an occupant of the vehicle, a step of reading in a piece of sensor information about an occupancy state of the vehicle seat and/or an occupant sitting on the vehicle seat, and a step of using the piece of driving task transfer information and the piece of sensor information to release or regulate the driving task transfer.

### FIELD OF THE INVENTION

The present invention is directed to a device or to a method. The present invention also relates to a computer program.

### BACKGROUND INFORMATION

In the future, automated driving will decisively shape traffic. The automotive industry is therefore working on the constant refinement of automatically driving vehicles. Semi-automatic functions are already the state of the art. By the year 2020, for example, the step toward full automation will follow, in which vehicles will be able to drive without a “driver in the loop.” This means that the driver or driving occupant of the vehicle transfers the driving responsibility for certain driving intervals to the vehicle.

### SUMMARY

Against this background, the approach described here introduces a method for monitoring or regulating a driving task transfer in an autonomous vehicle, a device which uses this method, a system for a driving task transfer in an autonomous vehicle, furthermore an autonomous vehicle including such a system, and finally, a corresponding computer program.

A processing of a piece of information about an intended transfer of the driving task in an autonomous vehicle by an occupant of the vehicle and of a piece of sensor information about an occupancy state of a vehicle seat of the vehicle and/or an occupant sitting on the vehicle seat with the aid of a suitable algorithm allows a safe and robust design of the driving task transfer in the vehicle between occupants of the vehicle or between an occupant and the vehicle.

A method for monitoring or regulating a driving task transfer in an autonomous vehicle is introduced, the method including the following steps:
reading in a piece of driving task transfer information from an interface assigned to a vehicle seat of the vehicle, the piece of driving task transfer information representing an intended transfer of the driving task by an occupant of the vehicle;
reading in a piece of sensor information about an occupancy state of the vehicle seat and/or an occupant sitting on the vehicle seat; and
using the piece of driving task transfer information and the piece of sensor information to release or to refuse or to regulate the driving task transfer.

The method may be suitable for being carried out in an autonomous vehicle. The driving task transfer may be monitored, regulated or also only controlled by the method. The autonomous vehicle may be a road-bound vehicle, such as a passenger car or a truck, which is designed to assume the driving task—i.e., the task of driving the vehicle in a traffic space—itself at least for a certain time period. This means that the vehicle moves autonomously in the traffic space with the aid of suitable sensors and control units installed in the vehicle, and a vehicle driving activity of an occupant of the vehicle representing a driver of the vehicle is completely dispensed with. The occupant is then not in charge of the driving task for this time period and is only a passive passenger in the vehicle. The driving task transfer may describe a transfer of the driving task between the vehicle and the occupant, or also between the occupant and a further occupant of the vehicle. The piece of driving task transfer information and/or the piece of sensor information may be processed data of signals of sensors suitably situated in the vehicle. For example, the piece of driving task transfer information may be formed with the involvement of data from touch sensors installed in the steering wheel of the vehicle. The piece of sensor information may be formed with the involvement of data from optical sensors installed in the vehicle. In this context, an interface assigned to a vehicle seat of the vehicle may be understood to mean an interface which reads in a piece of information from or about an occupant sitting on the vehicle seat which is assigned to the interface. For example, the piece of information may represent a parameter such as an occupancy of the seat which is assigned to the interface or represent a movement of the hand of the vehicle occupant who is sitting on the vehicle seat assigned to the interface.

This method may be implemented in software or hardware or in a mixed form made up of software and hardware, for example in a control unit.

According to the concept provided here, the driving task may be transferred back to the driver of the vehicle in a safe and smooth process even after extended automated driving periods.

According to one specific embodiment, the driving task transfer may be released in the step of using when the occupancy state represents an occupancy of the vehicle seat by the occupant. In the step of using, the driving task transfer may be refused when the occupancy state represents a non-occupancy of the vehicle seat by the occupant. This specific embodiment allows a simple verification of the seat occupancy to be carried out, which prevents the driving task from being transferred to an occupant of the vehicle who is not authorized to carry out the driving task or whose readiness to assume the driving task was erroneously detected.

According to one further specific embodiment, in the step of reading in a piece of sensor information, the piece of sensor information may include a piece of classification information for an assignment of the occupant to at least one first occupant class or one second occupant class. The first occupant class may represent a group of occupants registered and/or authorized to carry out the driving task, and the second occupant class may represent a group of occupants not registered and/or not authorized to carry out the driving task. In particular, in the step of using, the driving task transfer may be released when the occupant is assigned to the first occupant class based on the piece of classification information. Alternatively, in the step of using, the driving task transfer may be refused when the occupant is assigned to the second occupant class based on the piece of classification information. In this way, it may be readily ensured that persons not authorized to drive or not suitable for driving the vehicle are not able to assume the driving task.

For example, in the step of reading in a piece of sensor information, the piece of sensor information may be read in via an interface to a 3D sensor of the vehicle. A 3D sensor is particularly suitable for the quick and uncomplex classification of vehicle occupants.

It is also favorable if, in the step of reading in a piece of sensor information, the piece of sensor information includes a piece of identification information for identifying the occupant as an occupant distinguishable from at least one other occupant. In particular, the driving task transfer may be released in the step of using when the occupant is identified based on the piece of identification information. The driving task may thus advantageously be transferred in an individualized manner.

For example, in the step of reading in a piece of sensor information, the piece of sensor information may be read in via an interface to an occupant monitoring camera of the vehicle. By using an occupant monitoring camera, the occupant may advantageously be clearly identified.

Furthermore, a transfer instruction for a condition of the driving task transfer may be used in the step of using. In particular, the driving task transfer may be released in the step of using when the transfer instruction is complied with. Alternatively, the driving task transfer may be refused in the step of using when the transfer instruction is not complied with. In this way, it may be readily ensured that the driving task may only be transferred when the conditions for proper and safe driving of the vehicle according to instructions are complied with by the occupant.

According to one specific embodiment, in the step of reading in a piece of driving task transfer information, the driving task transfer information may include a piece of gesture information about a gesture of the occupant representing the intended transfer of the driving task and/or an activation signal representing an activation of a device for indicating the intended transfer of the driving task. In this way, the intended transfer of the driving task by an occupant of the vehicle may be identified quickly and reliably.

It is also favorable when the method includes a step of providing a driving safety signal to an interface to a driver assistance control unit of the vehicle when the driving task transfer was refused in the step of using. The driving safety signal may be designed to effectuate an action maintaining or establishing the driving safety of the vehicle, by a driver assistance device of the vehicle coupled to the driver assistance control unit. In this way, a driving safety of the vehicle may advantageously be ensured without limitations when the driving task transfer is refused.

The method may furthermore include a step of providing an information signal to a user interface to the vehicle seat when the driving task transfer was refused in the step of using. The information signal may be designed to effectuate an output of a piece of information for establishing a prerequisite for a release of the driving task transfer at the user interface or an information output device assigned to the user interface. In this way, the option of creating suitable conditions for the driving task transfer may be readily given.

The approach described here furthermore creates a device which is designed to carry out, activate or implement the steps of one variant of a method described here in corresponding devices. The object underlying the present invention may also be achieved quickly and efficiently by this embodiment variant of the present invention in the form of a device.

For this purpose, the device may include at least one processing unit for processing signals or data, at least one memory unit for storing signals or data, at least one interface to a sensor or an actuator for reading in sensor signals from the sensor or for outputting data signals or control signals to the actuator and/or at least one communication interface for reading in or outputting data which are embedded into a communication protocol. The processing unit may be a signal processor, a microcontroller or the like, for example, it being possible for the memory unit to be a Flash memory, an EPROM or a magnetic memory unit. The communication interface may be designed to read in or output data wirelessly and/or in a wire-bound manner, a communication interface which is able to read in or output wire-bound data being able to read these data in, for example electrically or optically, from a corresponding data transmission line or output these into a corresponding data transmission line.

A device in the present case may be understood to mean an electrical device which processes sensor signals and outputs control and/or data signals as a function thereof. The device may include an interface which may be designed as hardware and/or software. In the case of a hardware design, the interfaces may, for example, be part of a so-called system ASIC which includes a wide variety of functions of the device. However, it is also possible for the interfaces to be separate integrated circuits, or to be at least partially made up of discrete elements. In the case of a software design, the interfaces may be software modules which are present on a microcontroller, for example, in addition to other software modules.

In one advantageous embodiment, the device carries out a control of the driving task transfer in the automated vehicle. For this purpose, the device may access sensor signals of optical sensors and/or touch sensors and/or pressure sensors in the vehicle, for example.

Furthermore, a system for a driving task transfer in an autonomous vehicle is introduced, the system including the following features:
a device as described above;
a sensor system for monitoring a passenger compartment of the vehicle;
a driver assistance control unit for controlling at least one driver assistance device of the vehicle; and
a user interface to a vehicle seat of the vehicle, the device being electrically conductively coupled or coupleable to the sensor system and/or the driver assistance control unit and/or the user interface.

Finally, an autonomous system including a system as described above is introduced.

Also advantageous is a computer program product or a computer program, having program code which may be stored on a machine-readable carrier or storage medium such as a semiconductor memory, a hard disk memory or an optical memory, and which is used to carry out, implement and/or activate the steps of the method according to one of the specific embodiments described above, in particular if the program product or program is executed on a computer or a device.

### BRIEF DESCRIPTION OF THE DRAWINGS

FIG. 1 shows a schematic representation of an autonomous vehicle including a device for monitoring a driving task transfer according to one exemplary embodiment.

FIG. 2 shows a block diagram of a device for monitoring or regulating a driving task transfer in an autonomous vehicle according to one exemplary embodiment.

FIG. 3 shows a flow chart of a method for monitoring or regulating a driving task transfer in an autonomous vehicle according to one exemplary embodiment.

FIG. 4 shows a schematic representation of a passenger compartment of an autonomous vehicle according to one exemplary embodiment.

### DETAILED DESCRIPTION

In the following description of favorable exemplary embodiments of the present invention, identical or similar reference numerals are used for similarly acting elements shown in the different figures, and a repeated description of these elements is dispensed with.

Based on a schematic representation, FIG. 1 shows one exemplary embodiment of a vehicle 100 including a system 102 for a driving task transfer in vehicle 100. Vehicle 100 is an autonomous vehicle 100. Vehicle 100 is thus able to navigate, i.e., to drive, to steer and also to park, for example, autonomously, i.e., without intervention by a driver of vehicle 100, at least intermittently in a traffic space. The automated or autonomous driving of vehicle 100 takes place, for example, using sensors installed in vehicle 100 and at least one driver assistance device of vehicle 100. The exemplary autonomous vehicle 100 shown in FIG. 1 is a passenger car.

System 102 of autonomous vehicle 100 shown in FIG. 1 includes a device 104 for monitoring or regulating a driving task transfer in vehicle 100, a sensor system 106 for monitoring a passenger compartment of vehicle 100, a driver assistance control unit 108 for controlling at least one driver assistance device of vehicle 100, and at least one user interface or one HMI 110. Device 104 is electrically conductively coupled to sensor system 106, driver assistance control unit 108, and user interface 110.

In exemplary vehicle 100 shown in FIG. 1, one vehicle seat 112 is occupied by an occupant 114. A further vehicle seat 116 is occupied by a further occupant 118. Vehicle seats 112, 116 are front seats in a passenger cabin of vehicle 100, vehicle seat 112 representing classic driver's seat 112 of the vehicle, and further vehicle seat 116 representing classic front passenger seat 116 of vehicle 100. Exemplary autonomous vehicle 100 shown in FIG. 1 is designed in such a way that the driving task may be handled from multiple positions in the passenger compartment. For example, occupant 114 sitting on driver's seat 112 may assume the driving task in the same manner as further occupant 118 sitting on front passenger seat 116. Exemplary vehicle seats 112, 116 are rotatably situated in the passenger cabin and may thus be arbitrarily oriented in vehicle 100.

To initiate an exemplary driving task transfer or driving task transfer from vehicle 100 to occupant 114, device 104 reads in a piece of driving task transfer information 120 from an interface assigned to vehicle seat 112. Piece of driving task transfer information 120 represents an intended transfer of the driving task by occupant 114 of vehicle 100. Occupant 114 signals his or her intention to assume the driving task, for example as shown in FIG. 1 by placing the hands on a steering wheel of vehicle 100. In this case, piece of driving task transfer information 120 is based on data from touch sensors or pressure sensors installed in the steering wheel, which detect occupant 114 placing the hands on the steering wheel.

According to one exemplary embodiment, piece of driving task transfer information 120 may include data of a gesture carried out by occupant 114 and detected by sensor system 106 for signaling the readiness of occupant 114 to assume the driving task. According to one further exemplary embodiment, piece of driving task transfer information 120 may be based on data of an activation of a button in the dashboard area of vehicle 100, which is carried out by occupant 114 to signal his or her readiness to assume the driving task.

To decide whether the driving task transfer to occupant 114 is to be regulated, here, for example, released or refused, device 104 furthermore reads in a piece of sensor information 122 about an occupancy state of vehicle seat 112 and/or about occupant 114 sitting on vehicle seat 112. Piece of sensor information 122 is provided by sensor system 106 of vehicle 100. Using piece of driving task transfer information 120 and piece of sensor information 122, device 104 decides with the aid of a suitable algorithm whether the driving task transfer is released or refused.

In the exemplary embodiment shown in FIG. 1, sensor system 106 includes a 3D sensor 124 and an occupant monitoring camera 126 or an optical sensor of an occupant monitoring camera 126. Depending on the exemplary embodiment, piece of sensor information 122 may include data of both 3D sensor 124 and of occupant monitoring camera 126, or alternatively may include data of only 3D sensor 124 or only occupant monitoring camera 126.

In the exemplary system shown in FIG. 1, device 104 ascertains based on piece of sensor information 122 that vehicle seat 112, from whose interface piece of driving task transfer information 120 was provided, is occupied by occupant 114, and decides thereupon, among other things, to release the driving task transfer to occupant 114. The occupancy of vehicle seats 112, 116 may in particular be detected by 3D sensor 124 installed, for example, on the vehicle roof lining.

Alternatively, piece of sensor information 122 may also enable an identification of occupant 114 in device 104. For example, the driving task is only transferred to occupant 114 when he or she is registered as a possible driver of vehicle 100. The identification of occupant 114 may in particular be enabled by data from occupant monitoring camera 126. For this purpose, occupant monitoring camera 126 is installed in the dashboard area of vehicle 100, for example.

In the exemplary system shown in FIG. 1 to explain the concept introduced herein for safeguarding the driving task transfer in automated vehicles, the driving task is only to be transferred to occupants 114, 118 of vehicle 100 authorized and/or registered to carry out the driving task. If, in the exemplary system shown in FIG. 1, further occupant 118 triggers piece of driving task transfer information 120, for example by pressing a button on HMI 110 assigned to further vehicle seat 116, device 104 using piece of sensor information 122 identifies further occupant 118 as not being a registered driver of vehicle 100 and accordingly refuses the driving task transfer to further occupant 118.

According to one exemplary embodiment of the concept introduced here, a driving safety signal 128 is provided to driving assistance control unit 108 in conjunction with the refusal of the driving task transfer, which in response to driving safety signal 128 triggers a safe stop of vehicle 100 with the aid of a driver assistance device coupled to driver assistance control unit 108. Furthermore, to notify further vehicle occupant 118, a corresponding information signal 130 is provided to user interface 110 assigned to further vehicle seat 116.

According to one exemplary embodiment, a transfer instruction for a condition of the driving task transfer may be incorporated in the decision algorithm of device 104. In this way, device 104 may refuse the driving task transfer when it is derived from sensor information 122 that, e.g., vehicle seat 112 of occupant 114 intending to assume the driving task is not oriented toward a driving direction of vehicle 100.

Within the context of a control unit, device 104 processes sensor signals 120, 122 or video signals 120, 122 of sensors 124, 126 and analyzes the images based on the computer vision algorithms described there. Device 104 forms an interface—e.g., via CAN or Ethernet—to control unit 108, and if necessary further control units of the driver assistance systems and automated driving functions of vehicle 100, to effectuate, for example in the case of a refused driving task transfer, that vehicle 100 remains in the automated driving mode. Device 104 furthermore provides piece of information 130 to HMI 108 via an interface.

For the driver identification, sensor system 106 preferably includes occupant monitoring camera 126, which hereafter is also referred to by the more common term “driver monitoring camera.” Driver monitoring camera 126 is preferably installed looking frontally at occupant 114 so that the lens may supply an image of the front head of occupant 114. These optical data are used in the algorithms integrated into device 104 for face recognition to carry out a driver identification or verification of occupant 114. To be able to optically cover multiple seats 112, 116 in the passenger cabin, the use of multiple driver monitoring cameras 126 is advantageous, for example one each for driver's seat 112 and front passenger seat 116.

For driver classification and/or locating, sensor system 106 includes 3D sensor 124, which is preferably installed in the roof lining of vehicle 100 to have a preferably comprehensive view of seats 112, 116 in vehicle 100 from above with the aid of a wide-angle lens. It is possible to use multiple 3D sensors 124. Alternatively, 3D sensors 124 may also be installed in a structural unit together with driver monitoring camera 126 in order to look frontally at occupants 114, 118. In this way, it is possible to identify a seat occupancy, e.g., by comparing “normal” surface image points of an empty seat to the changed image points of an occupied seat. Furthermore, 3D sensor 124 may classify occupants 114, 118, e.g., based on their size and their girth. For example, 3D sensor 124 may carry out a volume calculation of the torso of an occupant 114, 118 and thus enable a differentiation between children and adults.

Control unit 108 of the driver assistance systems or automated driving functions receives driving safety signal 128, and if necessary further signals, from device 104 and decides based on these on the system behavior of the current driving mode. In this way, control unit 108 triggers a safe stop of vehicle 100, for example in the case of a refused transfer of the driving task to further occupant 118. In the safe stop, vehicle 100 is brought into a safe state in an automated manner, for example stopped on the emergency lane with the emergency flashers activated.

If needed, HMI 110 provides feedback to occupants 114, 118 about those seats and occupants in vehicle 100 authorized for a transfer of the driving task in vehicle 100. In the case of refusal of the driving task transfer, an occupant is provided with an explanation of the refusal of the driving task transfer using information signal 130. As an alternative or in addition, the occupant is notified of an action necessary for the release of the driving task transfer. An action to be carried out for the driving task transfer could be announced on HMI 110, e.g., in text form using the following prompt: “Please orient seat toward driving direction to assume driving task.”

For observing the vehicle passenger compartment, sensor system 106 includes one or multiple 3D sensors 124 and one or multiple driver monitoring cameras 126. Driver monitoring camera 126 is implemented, for example, as a video camera which is installed on the steering column or in the area of the instrument cluster of vehicle 100 and usually equipped with active infrared lighting. Driver monitoring camera 126 is designed to identify the face of driver 114 and his or her features, among other things with the aid of image analysis algorithms.

3D sensor 124 may be implemented, for example, as a stereo video camera, such as is used, e.g., also in the exterior for driver assistance systems, or as a laser scanner, which is also used, e.g., in the vehicle exterior area, among other things for automated driving functions.

According to a particularly preferred exemplary embodiment, 3D sensor 124 is a time-of-flight sensor 124, which may also be referred to as a TOF camera. TOF cameras are 3D camera systems which measure distances using the time-of-flight (TOF) method. For this purpose, the scene, e.g., the passenger cabin of autonomous vehicle 100, is illuminated with the aid of a light pulse, and for every image point, camera 124 measures the time required for the light to travel to the object and back. For every image point, camera 124 thus supplies the distance of the object depicted thereon. The principle corresponds to laser scanning, with the advantage that an entire scene is recorded at once and does not have to be scanned.

According to one further preferred exemplary embodiment, 3D sensor 124 is designed as a structured light sensor. Here, a projector illuminates the measuring object, e.g., vehicle seats 112, 116 and/or their occupants 114, 118, sequentially over time using patterns of parallel light and dark stripes of differing widths. Camera 124 registers the projected stripe pattern at a known viewing angle for projection and is thus able to calculate surface coordinates and identify whether a vehicle seat 112, 116 is occupied, and if so, whether by an adult or a child.

According to the concept introduced here, prior to and/or during the transfer of the driving task among occupants 114, 118 or between occupants 114, 118 and vehicle 100, passenger compartment sensor system 106 and its data are resorted to in automated driving of the vehicle, in particular to locate, to classify and to identify or verify occupants 114, 118.

To locate occupants 114, 118, i.e., to establish where occupants 114, 118 are sitting, preferably 3D sensor system 124, and alternatively or additionally driver monitoring camera 126, are used. To classify occupants 114, 118, i.e., to establish where what type of occupant is sitting, preferably again 3D sensor system 124, and alternatively or additionally driver monitoring camera 126, are used. To identify or to verify occupants 114, 118, i.e., to establish which occupant previously authorized to carry out the driving task and registered by vehicle 100 is sitting where, preferably driver monitoring camera 126, and alternatively or additionally 3D sensor 124, are used.

Sensor system 106 is also used to check further actions of occupants 114, 118, for example to verify a signaled transfer readiness of an occupant 114, 118, i.e., to establish e.g. whether—as shown by way of example in FIG. 1—it is truly the hands of occupant 114 present on the steering unit, and not the hands of further occupant 118 from neighboring seat 116, or to establish who has pressed a button for the transfer of the driving task.

In this way, the risk of the improper transfer of the driving task, or transfer not intended or not desired by occupant 114, 118, may be minimized or eliminated. This may be implemented in that, for example for certain user groups, a transfer of the driving task is temporarily or permanently refused or conditions are communicated via HMI 110 to occupants 114, 118 which must be complied with for a driving task transfer. The concept introduced herein is thus in particular suitable for use in vehicles in which the driving task is not limited solely to occupant 114 sitting in driver's seat 112, but may be handled from various seat positions, e.g., also from front passenger seat 116.

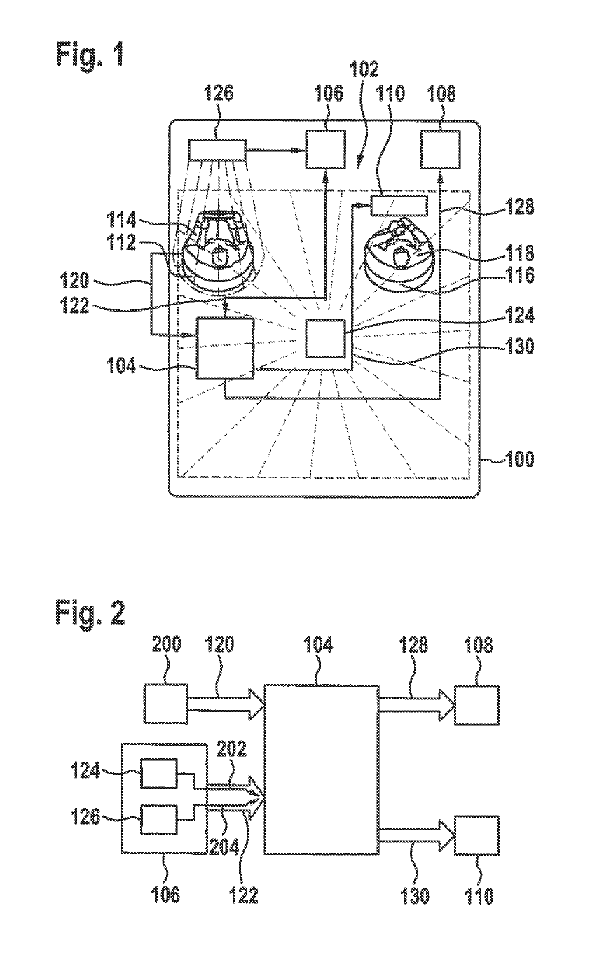

FIG. 2 shows a block diagram of one exemplary embodiment of device 104 for monitoring or regulating or controlling a driving task transfer in an autonomous vehicle.

Device 104 is designed to read in piece of driving task transfer information 120 from an interface 200 assigned to a vehicle seat of a vehicle via an input interface. Device 104 is furthermore designed to read in piece of sensor information 122 about an occupancy state of the vehicle seat and/or an occupant sitting on the vehicle seat from sensor system 106 via the input interface.

Piece of driving task transfer information 120 may include, for example, a piece of gesture information about a gesture of the occupant representing the intended transfer of the driving task, and additionally or alternatively an activation signal representing an activation of a device for indicating the intended transfer of the driving task.

According to one exemplary embodiment, piece of sensor information 122 includes a piece of classification information 202 for an assignment of the occupant to at least one first occupant class of occupants registered and/or authorized to carry out the driving task or a second occupant class of occupants not registered and/or not authorized to carry out the driving task. In the exemplary embodiment of device 104 shown in FIG. 2, piece of classification information 202 is provided by 3D sensor 124 of sensor system 106.

According to one exemplary embodiment, piece of sensor information 122 furthermore includes a piece of identification information 204 for identifying the occupant as an occupant distinguishable from at least one other occupant of vehicle. In the exemplary embodiment of device 104 shown in FIG. 2, piece of identification information 204 is provided by occupant monitoring camera 126 of sensor system 106.

Device 104 uses one or multiple algorithms to decide, using piece of driving task transfer information 120 and piece of sensor information 122, whether the driving task is released or refused with respect to the occupant of the vehicle. At least one transfer instruction stored in the device for a proper driving task transfer may be incorporated in the decision-making process.

If device 104 decides to refuse the driving task transfer, driving safety signal 128 is provided to driver assistance control unit 108 and/or information signal 130 is provided to user interface 110.

Device 104 is designed to ascertain a preclusion of occupants or seats in the driving task transfer using piece of sensor information 122. In particular, a seat in the vehicle is precluded from the driving task transfer if it is empty, if it is occupied by an occupant classified or identified as a child, and if it, although occupied by an occupant, is set counter to the driving direction.

According to one exemplary embodiment, device 104 may be designed, for example, to preclude, from the driving task transfer, seats having occupants who are not released by the vehicle owner for the driving task, based on information stored by the vehicle owner. For this purpose, for example, a prior manual setting on device 104 or a unit connected to the device is possible, e.g., by a registration of certain users by the vehicle owner.

The use of the transfer instruction in device 104 furthermore allows the identification of a proper transfer of the driving task, for example by checking whether in fact the specific occupant of a seat has signaled his or her transfer readiness of the driving task by manual inputs—e.g., the push of a button or placement of the hands on the steering unit—and this did not intentionally or accidentally occur by the occupant of a neighboring seat.

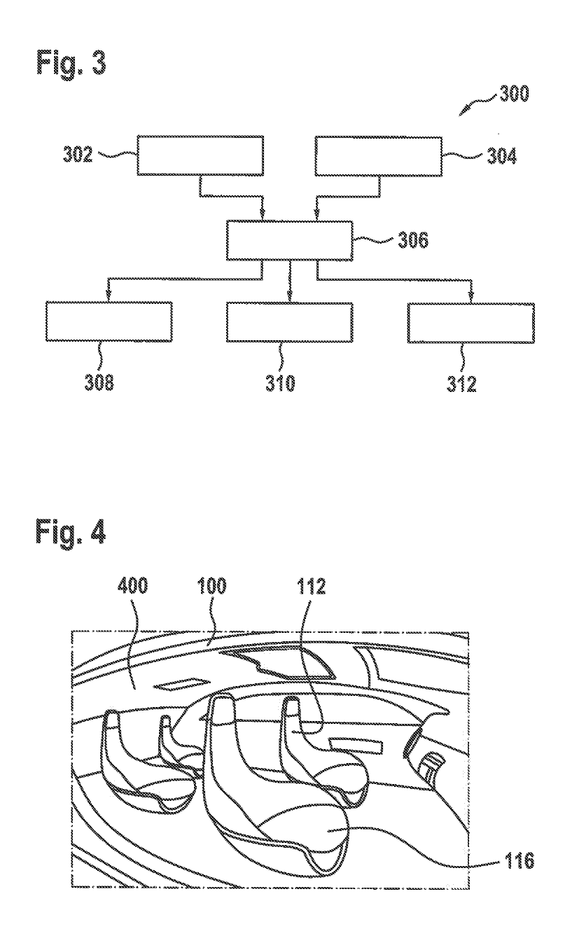

FIG. 3 shows a flow chart of one exemplary embodiment of a method 300 for monitoring or regulating a driving task transfer in an autonomous vehicle. Method 300 may be carried out to monitor or safeguard the driving task transfer in the autonomous vehicle shown in FIG. 1.

In a first step of reading in 302, a piece of driving task transfer information about an intended transfer of the driving task is read in by an interface assigned to a vehicle seat of the vehicle. In a second step of reading in 304, a piece of sensor information about an occupancy state of the vehicle seat and/or about an occupant sitting on the vehicle seat is read in. For example, the piece of sensor information contains a verification of the occupant intending to assume the driving task as an authorized driver or information as to whether or not the occupant intending to assume the driving task belongs to a group of persons registered or authorized to carry out the driving task.

In a step of using 306, the piece of driving task transfer information and the piece of sensor information are used to make a decision whether the driving task transfer is released or refused for the occupant, i.e., regulated.

If it is decided in the step of using 306 that the driving task transfer is released for the occupant, a deactivation of devices of the vehicle previously in charge of the driving task, such as driver assistance systems, follows in a step 308. The occupant is now able to drive the vehicle on his or her own responsibility as the driver.

If it is decided in the step of using 306 that the driving task transfer is refused to the occupant, a driving safety signal is provided to an interface to a driver assistance control unit of the vehicle in a first step of providing 310 to maintain the vehicle in the automated driving mode. Furthermore, in a second step of proving 312, an information signal is provided to a user interface assigned to the vehicle seat of the occupant to notify the occupant via an output unit of the user interface of a reason for the transfer refusal, or to provide him or her with an instruction to establish a condition for a proper driving task transfer.

FIG. 4 shows a schematic representation of one exemplary embodiment of a passenger compartment 400 of an exemplary autonomous vehicle 100, in which the concept introduced herein of monitoring the driving task transfer may be advantageously implemented. Shown are driver's seat 112, front passenger seat 116, and two further seats in the rear of passenger compartment 400. In the exemplary embodiment shown in FIG. 4, all vehicle seats 112, 116 are mounted rotatably 360° about a rotational axis. The driving task may be handled from multiple vehicle seats of vehicle 100, at least from driver's seat 112 and from front passenger seat 116.

If one exemplary embodiment includes an “and/or” linkage between a first feature and a second feature, this should be read in such a way that the exemplary embodiment according to one specific embodiment includes both the first feature and the second feature, and according to an additional specific embodiment includes either only the first feature or only the second feature.

What is claimed is:

1. A method for one of monitoring and regulating a driving task transfer in an autonomous vehicle, comprising:
reading in a piece of driving task transfer information from an interface assigned to a vehicle seat of the vehicle, the piece of driving task transfer information representing an intended transfer of the driving task by an occupant of the vehicle;
reading in a piece of sensor information about at least one of an occupancy state of the vehicle seat and an occupant sitting on the vehicle seat; and
using the piece of driving task transfer information and the piece of sensor information one of to release and to regulate the driving task transfer.

2. The method as recited in claim 1, wherein at least one of:
in the step of using the driving task transfer is released when the occupancy state represents an occupancy of the vehicle seat by the occupant, and
in the step of using the driving task transfer is refused when the occupancy state represents a non-occupancy of the vehicle seat by the occupant.

3. The method as recited in claim 1, wherein:
in the step of reading in the piece of sensor information, the piece of sensor information includes a piece of classification information for assigning the occupant to one of at least one first occupant class and one second occupant class, the first occupant class representing a group of occupants at least one of registered and authorized to carry out the driving task, and the second occupant class representing a group of occupants at least one of not registered and not authorized to carry out the driving task.

4. The method as recited in claim 3, wherein at least one of:
in the step of using the driving task transfer is released when the occupant is assigned to the first occupant class based on the piece of classification information, and
in the step of using the driving task transfer is refused when the occupant is assigned to the second occupant class based on the piece of classification information.

5. The method as recited in claim 1, wherein:
in the step of reading in the piece of sensor information, the piece of sensor information is read in via an interface to a 3D sensor of the vehicle.

6. The method as recited in claim 1, wherein:
in the step of reading in the piece of sensor information, the piece of sensor information includes a piece of identification information for identifying the occupant as an occupant distinguishable from at least one other occupant. The method as recited in claim 6, wherein:
in the step of using the driving task transfer is released when the occupant is identified based on the piece of identification information.

8. The method as recited in claim 6, wherein:
in the step of reading in the piece of sensor information, the piece of sensor information is read in via an interface to an occupant monitoring camera of the vehicle.

9. The method as recited in claim 1, wherein:
in the step of using, a transfer instruction for a condition of the driving task transfer is used.

10. The method as recited in claim 9, wherein at least one of:
in the step of using the driving task transfer is released if the transfer instruction is complied with, and
in the step of using the driving task transfer is refused if the transfer instruction is not complied with.

11. The method as recited in claim 1, wherein:
in the step of reading in the piece of driving task transfer information, the piece of driving task transfer information includes at least one of:
a piece of gesture information about a gesture of the occupant representing the intended transfer of the driving task, and
an activation signal representing an activation of a device for indicating the intended transfer of the driving task.

12. The method as recited in claim 1, further comprising:
providing a driving safety signal to an interface to a driver assistance control unit of the vehicle when the driving task transfer was refused in the step of using, the driving safety signal effectuating an action one of maintaining and establishing a driving safety of the vehicle, by a driver assistance device of the vehicle coupled to the driver assistance control unit.

13. The method as recited in claim 1, further comprising:
providing an information signal to a user interface to the vehicle seat when in the step of using the driving task transfer was refused, the information signal effectuating an output of a piece of information for establishing a prerequisite for a release of the driving task transfer at the user interface.

14. A device for one of monitoring and regulating a driving task transfer in an autonomous vehicle, comprising:
an arrangement for reading in a piece of driving task transfer information from an interface assigned to a vehicle seat of the vehicle, the piece of driving task transfer information representing an intended transfer of the driving task by an occupant of the vehicle;
an arrangement for reading in a piece of sensor information about at least one of an occupancy state of the vehicle seat and an occupant sitting on the vehicle seat; and
an arrangement for using the piece of driving task transfer information and the piece of sensor information one of to release and to regulate the driving task transfer.

15. A system for a driving task transfer in an autonomous vehicle, comprising:
a device for one of monitoring and regulating a driving task transfer in an autonomous vehicle, the device including:
an arrangement for reading in a piece of driving task transfer information from an interface assigned to a vehicle seat of the vehicle, the piece of driving task transfer information representing an intended transfer of the driving task by an occupant of the vehicle;
an arrangement for reading in a piece of sensor information about at least one of an occupancy state of the vehicle seat and an occupant sitting on the vehicle seat; and
an arrangement for using the piece of driving task transfer information and the piece of sensor information one of to release and to regulate the driving task transfer;
a sensor system for monitoring a passenger compartment of the vehicle;
a driver assistance control unit for controlling at least one driver assistance device of the vehicle; and
a user interface to the vehicle seat of the vehicle, wherein the device is electrically conductively coupled or couplable to at least one of the sensor system, the driver assistance control unit, and the user interface.

16. A computer program configured to carry out a method for one of monitoring and regulating a driving task transfer in an autonomous vehicle, the method comprising:
reading in a piece of driving task transfer information from an interface assigned to a vehicle seat of the vehicle, the piece of driving task transfer information representing an intended transfer of the driving task by an occupant of the vehicle;
reading in a piece of sensor information about at least one of an occupancy state of the vehicle seat and an occupant sitting on the vehicle seat; and
using the piece of driving task transfer information and the piece of sensor information one of to release and to regulate the driving task transfer.

17. A machine-readable storage medium on which is stored a computer program configured to carry out a method for one of monitoring and regulating a driving task transfer in an autonomous vehicle, the method comprising:
reading in a piece of driving task transfer information from an interface assigned to a vehicle seat of the vehicle, the piece of driving task transfer information representing an intended transfer of the driving task by an occupant of the vehicle;
reading in a piece of sensor information about at least one of an occupancy state of the vehicle seat and an occupant sitting on the vehicle seat; and
using the piece of driving task transfer information and the piece of sensor information one of to release and to regulate the driving task transfer.
